(19) United States
(12) Patent Application Publication
(10) Pub. No.: US 2004/0119894 A1
(43) Pub. Date: Jun. 24, 2004

(54) System and method for programming a programmable remote control device

(76) Inventors: Rich Higgins, Colorado Springs, CO (US); Jeff Henry, Ridgefield, CT (US); Remi Rieger, Charlotte, NC (US)

Correspondence Address: ROBERTS ABOKHAIR & MARDULA, SUITE 1000, 11800 SUNRISE VALLEY DRIVE, RESTON, VA, 20191, US

(21) Appl. No.: 10/328,398

(22) Filed: Dec. 24, 2002

(51) Int. Cl. H04N 7/173; H04N 5/44

(52) U.S. Cl. 348/734; 725/132

(57) ABSTRACT

A method wherein a programmable remote control (PRC) is programmed from a configuration file over a network. A user configuration file comprises data associating the user configuration file with a unique user and information about devices that a user desires to control with a PRC. A service provider uses the device records to find the appropriate remote control instruction set for each device to be controlled by the PRC. Upon notification of a change in the devices that a user desires to control, the service provider would update the user configuration file. Optionally, the service provider would not only program the PRC, but using the PRC would assist the user in programming each device that is controlled by the PRC (to the extent such devices are programmable).

### FIELD OF THE INVENTION

The present invention relates generally to the field of programming remote controls for consumer devices. More specifically, the present invention provides a method wherein a remote control is programmed by a third party over a network.

### BACKGROUND OF THE INVENTION

Consumer devices, particular audio and video devices, are accessible through wireless remote control units (remotes). Typically, remotes send commands using infrared (IR) light as the carrier. The IR command set is unique for each manufacturer and device specific.

The first such devices were simple television remotes that allowed a user to select a channel, a volume setting, and to power the television set on and off. As televisions began to offer more features, the remotes also evolved into more flexible, albeit more complex, devices.

In the 70's, VCRs were introduced and the era of multiple remotes was born. Not only were users compelled to deal with separate remotes, but also the devices these remotes controlled became “programmable.” VCRs could be programmed for specific channels and languages and to record a program at a time in the future. Televisions were not only programmable with respect to the language and viewing channel, but with respect to a myriad of audio and video options as well. The audio/video (AV) receiver arrived with the introduction of Dolby Surround Sound. The AV receiver was also controllable remotely and programmable adding another later of complexity. Today, a basic entertainment center comprises a television (or monitor), a VCR, a DVD player, an AV receiver, a CD player, a set top box (for cable), and a digital video receiver (for digital television and HDTV reception). Additionally, fans, lights, gas fireplaces and other appliances are controllable using IR remote controls.

The proliferation of remote controls lead some manufactures to include “learning remotes” with their products. For example, the remote that controls the television set typically has a set of basic buttons to control a VCR and a database of VCR remote control codes. The remote is “told” what model of VCR is being operated and selects a remote control instruction set for that VCR. The remote control instruction set associates buttons on the remote control with commands that can be executed by the VCR. Alternatively, some remotes come with a learning mode that allows the remote for one device to teach its command list to a “master” remote. Because the remote typically has a limited number of buttons, the learning or master remote typically cannot capture all of the commands of the teaching remote. Thus, the original remote must still be available to handle certain tasks.

A popular solution to the multiple-remote problem is the programmable remote control (PRC). The PRC emulates the functionality of remote controls made by a plurality of manufacturers. PRC's use programmable buttons, virtual buttons displayed on a screen, or a combination of the two. Various techniques are used to train a PRC, including downloading device codes from the Internet.

U.S. Pat. No. 6,104,334 issued to Allport and entitled “Portable Internet-Enabled Controller and Information Browser for Consumer Devices,” ('334) describes a number of alternative means for programming a PRC and the problems associated with each. '334 teaches a PRC with an integrated graphical display that does not utilize the television screen for programming purposes and that can obtain a remote control instruction set either from a pre-loaded database of such commands or over the Internet.

U.S. Pat. No. 5,410,326 issued to Goldstein entitled “Programmable Remote control Device For Interacting With a Plurality of Remotely Controlled Devices,” ('326) describes a PRC that receives programming information over a link to cable converter or a telephone interface. An aspect of the '326 patent is that the user need not perform any elaborated programming steps to program the PRC. The programming of the PRC is also described in terms of a service to be provided by a cable system head end to its subscribers. While programming a PRC through a third-party interface is helpful, the user of the PRC must still be knowledgeable about the devices that are controllable using the PRC. Should the PRC ever lose it's programming, the user must know which device codes to download. Similarly, if the user replaces the PRC or acquires a second PRC, the download process must be initiated by the consumer with knowledge of devices that the user desires to control with the PRC.

A recently proposed Home Audio Video Interoperability (HAVi) standard seeks to address some of these problems. The HAVi specification is a consumer electronics (CE) industry standard design to permit digital audio and video devices that conform to this standard, regardless of manufacturer, to interoperate when connected via a network in the consumer's home. The HAVi standard uses the digital IEEE-1394 network standard for data transfer between devices and the 1394 A/VC protocols for device control.

The HAVi standard focuses on the transfer and processing (for example, recording and playback) of digital content between networked devices. HAVi-compliant devices will include not only familiar audio and video components but also cable modems, digital set-top boxes and “smart” storage devices such as personal video recorders (PVRs). In the future, other kinds of devices such as videophones and personal digital assistants (PDAs) also may become part of a HAVi home network. By letting a TV set, or any other device on the network that has a display capability, act as a network hub to both control and show the status of any connected device, compliance with the HAVi standard will make consumer electronic equipment easier to use. In a HAVi-compliant system, all of the networked components can be run from the TV with one remote control. A home PC will not be required for a HAVi-compliant system to operate and is independent of any operating system or microprocessor. However, a PC can act as a HAVi-compliant device, with the ability to control other connected devices.

Compliance with the HAVi standard also allows disparate brand devices to be hooked into a home network. A DV camcorder, video game player or even a refrigerator conforming to the HAVi standard could be plugged into a network and have its features automatically available for use by other devices on the network. From the consumer's perspective, all that is required is to select a task for a device and the HAVi host will order the task performed.

By employing modular software, the HAVi standard allows consumer electronics devices to identify themselves and what they can do when plugged into the host. The software functions by assigning a device control ID module to each hardware component of a system. Each system also is assigned multiple functional component modules, containing information about an individual device's capabilities, for example, whether a camcorder operates in DV format, or whether a receiver is designed to process AC3 audio.

HAVi-compliant devices automatically register their operating status, device functions and location with other components in the network. So when a host device recognizes a new component on a HAVi system, the host loads the appropriate device and functional modules, allowing users to control the target device from the host.

The features promised by the HAVi standard will only be available for HAVi-compliant devices. Further, the HAVi standard anticipates that the graphical user interface of the network of components is displayed on a television or other video display component of the system, thus requiring the video display component to be powered on when using a system device. If a user desires to use only the audio components of a system the video display must still be powered on.

The IEEE1394 A/VC protocol, which is a lower software layer than HAVi, can also be used in conjunction with other IEEE 1394 protocols (collectively referred to as “A/VC protocol”) to transport configuration data among devices, although without HAVI interoperability of different brands is problematic. For example, a 1394 A/VC capable DVD could send profile information using the 1394 A/VC protocol to a compliant D-VCR. The D-VCR would then have access to the features of the DVD. As in the case of the HAVI standard, the 1394 A/VC protocol does not specifically address problems relating to programming a PRC nor does it guarantee inoperability among brands.

What would be useful would be a system and method whereby a service provider can program a PRC over a network using a user configuration file stored by the service provider and associated with the user.

### SUMMARY OF THE INVENTION

An embodiment of the present invention is a method of programming a PRC using a user configuration file held by a service provider. In this embodiment, the service provider is a cable operator from whom the user obtains cable service, but the present invention is not so limited. By way of example and not as a limitation, a service provider may be a third party offering PRC programming services independent of any other relationship with the user or a third party providing satellite entertainment services to the user. As will be apparent to those skilled in the art of the present invention, other third parties may provide the PRC programming service without departing from the scope of the present invention.

A user configuration file comprises data associating a user with a unique user configuration file. The user configuration file comprises information about devices (device data) that a user desires to control with a PRC. The service provider uses the device data to find the appropriate remote control instruction set for each device to be controlled by the PRC. The service provider conveys this remote control instruction set to the user for communication to the PRC. The remote control instruction set is then communicated to the PRC and the instructions implemented. Upon notification of a change in the devices that a user desires to control, the service provider updates the user configuration file.

It is an aspect of the present invention to eliminate the need for a user to program a PRC to operate with a device.

It is yet another aspect of the present invention for a service provider to maintain a user configuration file associated with a user wherein the user configuration file comprises a device record for each device that the user desires to control with a PRC.

It is still another aspect of the present invention for the user to notify the service provider of a change or addition to the set of devices that the user desires to control with a PRC and to receive from the service provider updated remote control instruction set for the user's PRC reflecting the change or addition.

It is an aspect of the present invention to obtain user configuration file data and updates to that data directly from a HAVi-compliant device.

It is an aspect of the present invention to permit the service provider to program one or more devices that are accessible through a user's PRC.

An embodiment of the present invention is a method of programming a PRC using a user configuration file held by a service provider. In this embodiment, a user configuration file comprises data associating a user with a unique user configuration file. The user configuration file comprises information about devices that a user desires to control with a PRC and the type of PRC possessed by the user. The service provider uses the device data to find the appropriate remote control instruction set for each device to be controlled by the PRC. The service provider conveys this remote control instruction set to the user for communication to the PRC. The remote control instruction set is then communicated to the PRC and the instructions implemented. Upon notification of a change in the devices that a user desires to control, the service provider updates the user configuration file. Optionally, the service provider not only programs the PRC but also assists the user in programming each device that is controlled by the PRC (to the extent such devices are programmable).

In another embodiment, a HAVi-compliant device (designated as the HAVi-complaint host) is connected to a plurality of HAVi-compliant devices. The HAVi-compliant devices share control information with each other and with the HAVi-compliant host. The HAVi-compliant host communicates the control information of each HAVi-compliant device connected to it to the service provider. From the control information, the service provider obtains the remote control instruction set for each HAVi-compliant device connected to the HAVi-compliant host. The remote control instruction sets are sent to the HAVi-compliant host, which in turn communicates the remote control instruction sets to a HAVi-compliant PRC and the instructions implemented.

### BRIEF SUMMARY OF THE DRAWINGS

FIGS. 1A and 1B illustrate a general flow chart of an embodiment of the present invention according to an embodiment of the present invention.

FIG. 2 illustrates a block diagram of a method of conveying information about devices that a user desires to control with a PRC to a service provider according to an embodiment of the present invention.

FIG. 3 illustrates a block diagram of a method of conveying information about devices that a user desires to control with a PRC to a service provider according to another embodiment of the present invention.

FIG. 4 illustrates a block diagram of a method of programming a PRC according to an embodiment of the present invention.

FIG. 5 illustrates a block diagram of a method of programming a PRC according to another embodiment of the present invention.

FIG. 6 illustrates a block diagram of a method of programming a PRC in a HAVi-compliant environment according to an embodiment of the present invention

### DETAILED DESCRIPTION OF EMBODIMENTS OF THE PRESENT INVENTION

An embodiment of the present invention is a method of programming a PRC using device data held in a user configuration file held by a service provider. As used herein, a “device” comprises equipment that is controllable by means of a remote control. By way of example and not as limitation, a device may be a VCR, a DVD player, a television, or other A/V equipment, or a thermostat, a lighting system, or a fan. As will be apparent to those skilled in the art, other equipment that is controllable by use of a remote control may be used in conjunction with the present invention without departing from its scope.

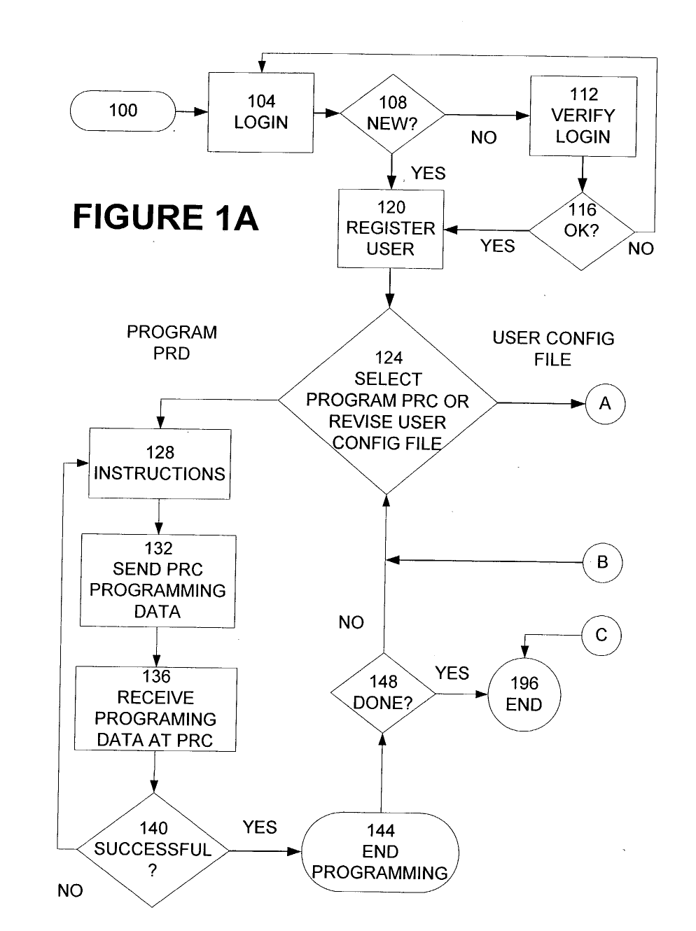

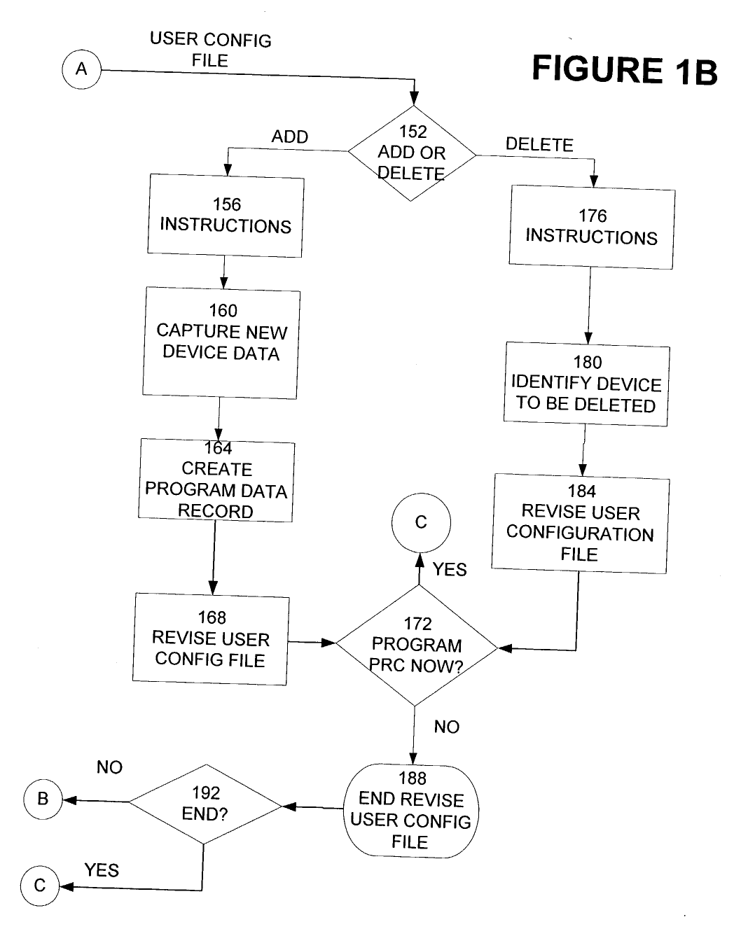

Referring to FIG. 1, a general flow chart of an embodiment of the present invention is illustrated. A user initiates communication with a service provider 100. Any number of means may be used for this communication, including by way of example and not as a limitation, using a user computer linked to the service provider over the public switched telephone network and using a user computer linked to the service provider over a cable network. The “computer” may be a PC, or it may be a set top box connected through a network to the service provider.

Once connected to the service provider, the user is asked to login 104. A check is made to determine if the user is a new user or is if the user claims to have an account with the service provider 108. If the user is new, the user registers with the service provider 120. If the user claims to have an account with the service provider, the user verifies the account using standard login practice 112 known in the art. If the verification fails, the user is returned to the login process 104. If the verification is successful, or if the user has completed the registration process, the user is invited to choose to either program a remote control using an existing user configuration file or to create or modify a user configuration file 124.

The process for programming a remote control from an existing user configuration file begins with instructions issued by the service provider 128 to the user. In one embodiment of the present invention, these instructions are general instructions as to how to program a remote control. In another embodiment, the instructions are tailored to the user based on the user profile. By way of illustration, in this latter embodiment, the user profile comprises the model of the remote control to be programmed and the interface through which the programming will be accomplished, and the instructions proffered to the user are specific to the remote and the interface. The means by which instructions are delivered to the user depend on the device being used to communicate with the service provider. For example, instructions are provided as images on communication devices having video display capabilities. In an alternative embodiment, the instructions may be provided in audio format.

The remote control instruction set is sent by the service provider 132 and received by the PRC to be programmed 136. The means by which the remote control instruction set is communicated to the PRC to be programmed is described below. In one embodiment, the remote control instruction set is provided over the Internet. In yet another embodiment, the remote control instruction set is provided over a cable network. However, these examples are not intended as limitations and as would be apparent to those skilled in the art of the present invention other means of conveying the remote control instruction set to the remote to be programmed may be used without departing from the scope of the present invention.

A check is made to determine if the programming of the remote was successful 140. If not, the instructions are issued again 128 and the programming process is repeated. If the programming is successful, the programming process ends 144 and a check is made to determine if the user has other tasks to perform 148. If no other tasks are to be performed, then the session with the service provider ends 196. If other tasks are to be performed, then the user is again asked to choose between programming a PRC or creating or modifying a user configuration file 124.

A user configuration file comprises information about devices that a user desires to control with a PRC and the device record associated with those devices and data associating the user configuration file with a unique user. In another embodiment of the present invention, the user configuration file further comprises information about a PRC and the interface by which the PRC receives device record. The device record is used to select a remote control instruction set for each device to be controlled by a PRC.

Referring again to FIG. 1, the flow following a user selection of creating or modifying a user configuration file is illustrated. The user selects whether information is being added to a user configuration file or deleted 152. If a device is being added to a configuration file, the user is presented with instructions 156 and the new device data is captured 160. A device record for the new device is added to a device record 164 and the user configuration file is updated 168.

If a device is to be deleted from the user configuration file, the user is presented with instructions 176 and the device to be deleted is identified. The user configuration file is updated 184.

Once a device has been added or deleted from the configuration file, the user is prompted as to whether the user desires to initiate reprogramming the user's PRC to reflect the revised configuration 172. If the user chooses to initiate programming the PRC, the process continues with the issuance of programming instructions 128. If the user elects not to program the PRC, revision of the user configuration file ends 188 and a check is made to determine if the user has other tasks to perform 192. If no other tasks are to be performed, then the session with the service provider ends 196. If other tasks are to be performed, then the user is again asked to choose between programming a remote or creating or modifying a user configuration file 124.

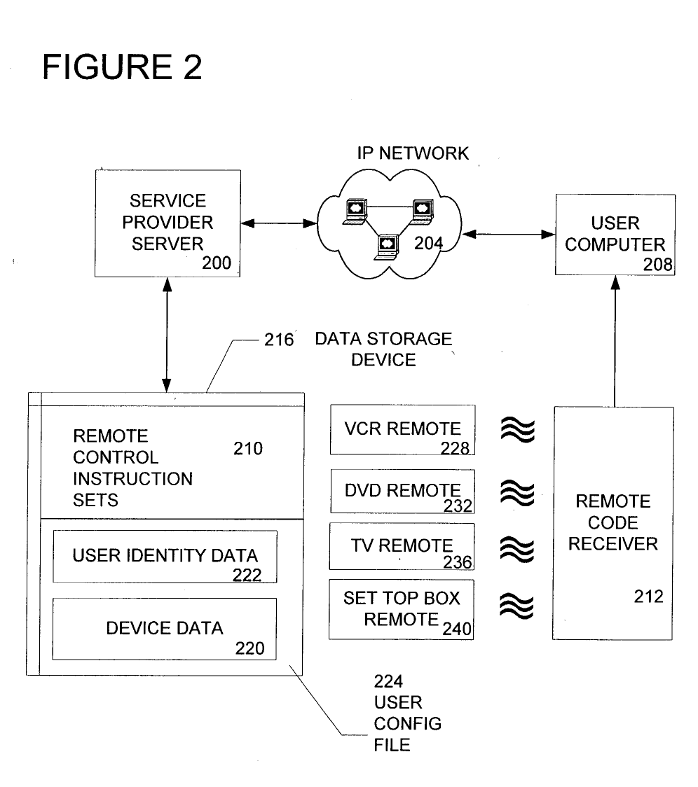

Referring to FIG. 2, a block diagram illustrating a method of conveying information about devices that a user desires to control with a PRC to a service provider. Configuration server 200 is connected to user computer 204 over network 208. User computer 204 is connected to remote code receiver 212. Configuration server 200 is connected to data storage device 216. Data storage device 216 comprises a user configuration file 224 and a file of remote control instruction sets 210. The file of remote control instruction sets 210 comprises a library of remote control instruction sets for a plurality of devices manufactured by a plurality of manufacturers.

User identity data 222 comprises information that associates the user configuration file 224 with a user. Device data 220 comprises device data that identifies devices of that user that are controllable remotely. By way of example, and not as a limitation, user configuration file 224 comprises device data 220 for a VCR, a DVD player, a television, and a set top box. This information is captured from VCR remote 228, DVD remote 232, TV remote 236, and set top box remote 240 through remote code receiver 216, each of which represent the remote control of the original equipment manufacturer of the device that it controls (an OEM remote). In this embodiment, an OEM remote is positioned so that its IR sending unit is capable of communicating with remote code receiver 216. A button of the OEM remote is pressed sending an encoded command to the remote code receiver 216 that in turn sends the encoded command to user computer 204.

In one embodiment, software on user computer 204 interprets the encoded command and determines the OEM of the OEM remote and the model of the product that the OEM remote controls. In another embodiment, the encoded command is sent to configuration server 200 and is interpreted by reference to the file of remote control instruction sets 210. In either embodiment, device data 220 relating to device to be controlled by the PRC is sent to user configuration file 224 and stored in association with a user identity data 222.

In another embodiment of the present invention, the remote command receiver is built into the PRC. In this embodiment, the PRC has an interface to the computer. By way of illustration and not as a limitation, the computer interface may be USB port, a serial port, IR, RF or other interface means.

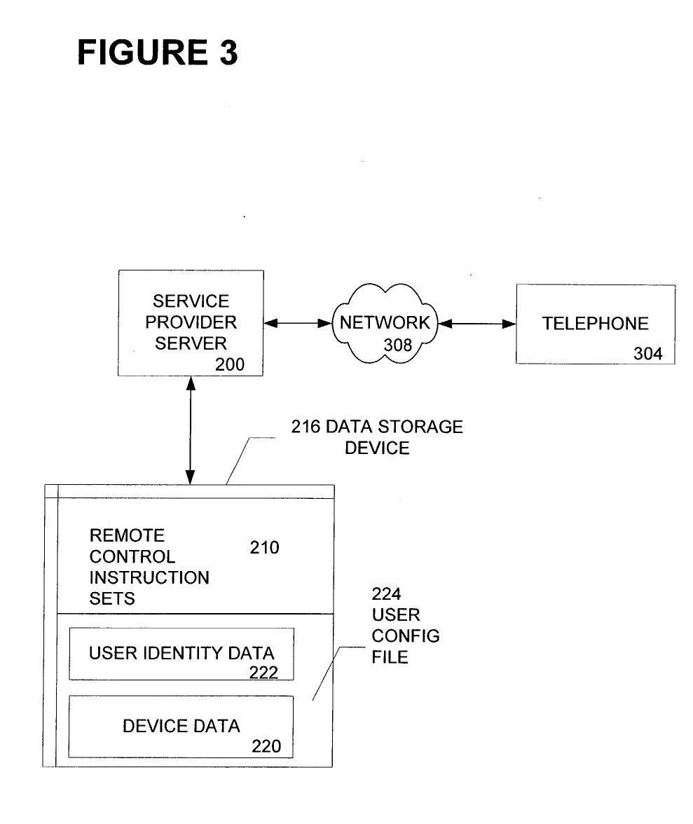

In another embodiment of the present invention, information about devices that a user desires to control with a PRC is conveyed to the service provider over the public switched telephone network (PSTN) or a wireless telephone network using a telephone. Referring to FIG. 3, configuration server 200 is connected to a telephone 304 over network 308. Configuration server 200 is connected to data storage device 216. Data storage device 216 comprises a file of remote control instruction sets 210 and a user configuration file 224. Using voice prompts, the service provider instructs the user to enter in the OEM of the device that the user desires to control with the PRC, the type of device (e.g., television, VCR, DVD), and other information necessary to identify the device. The user responds to the prompts by using the keypad of the telephone.

Once the user configuration file 224 is created, the device data 220 is used to select an appropriate remote control instruction set from the file of remote control instruction sets 210 for each device to be controlled by the PRC. The remote control instruction set is sent to the PRC.

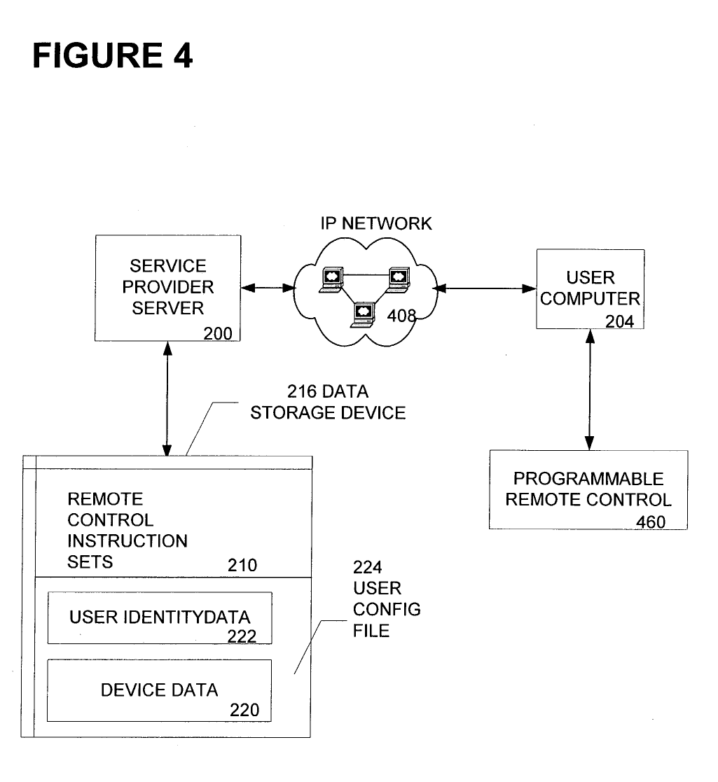

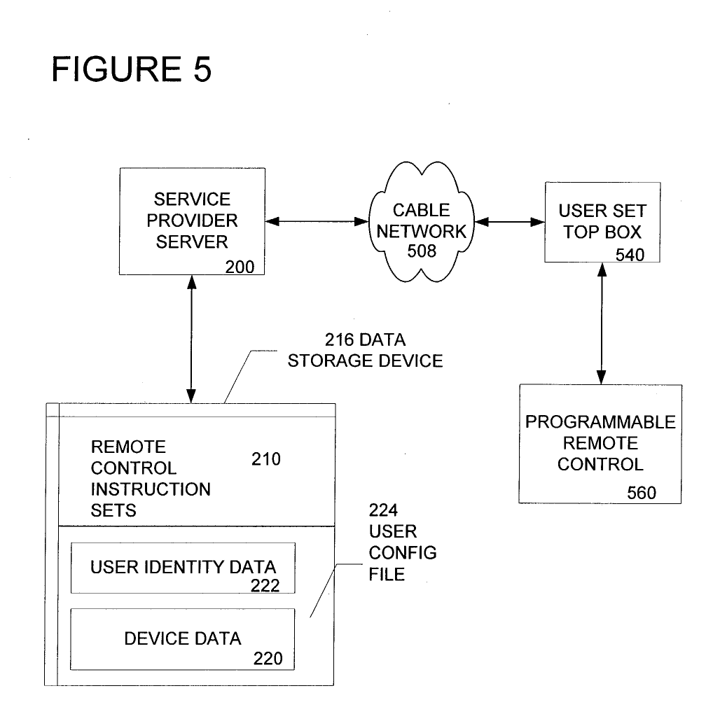

Referring to FIGS. 4 and 5, two embodiments of the present invention for programming a PRC from a user configuration file 224 are illustrated. In both embodiments, configuration server 200 is connected to data storage device 216. Data storage device 216 comprises a file of remote control instruction sets 210 and a user configuration file 224. User identity data 222 comprises information that associates the user configuration file 224 with a user. Device data 220 comprises device data that identifies devices of that user that are controllable remotely. By way of example, and not as a limitation, user configuration file 224 has device data 220 for a VCR, a DVD player, a television, and a set top box. This information is captured as previously described.

Referring to FIG. 4, configuration server 200 is connected to user computer 204 over IP network 408. A PRC 460 is also connected to user computer 204 through a computer interface. By way of illustration and not as a limitation, the computer interface may be USB port, a serial port, or other interface means. Service provider 220 uses the device data 220 to select from the file of remote control instruction sets 210 the appropriate remote control instruction set for each device for which data is held in device data 220. The remote control instruction sets are conveyed by configuration server 200 over IP network 408 to user computer 204 and loaded in the PRC 460 via the computer interface.

Referring to FIG. 5, configuration server 200 is connected to users set top box 540 over cable network 508. A PRC 560 is in communication with set top box 540 through an interface. By way of illustration and not as a limitation, the set top box interface may be USB port, a serial port, or an infrared link. The remote control instruction sets are conveyed by configuration server 200 over cable network 550 to set top box 540 and loaded in the PRC 560 via the set top box interface.

As will be apparent to those skilled in the art, other means of conveying the remote control instruction set to the PRC may be utilized without departing from the scope of the present invention. By way of illustration, the remote control instruction set may be downloaded into the user computer 208 and then loaded into the PRC using software provided by the service provider.

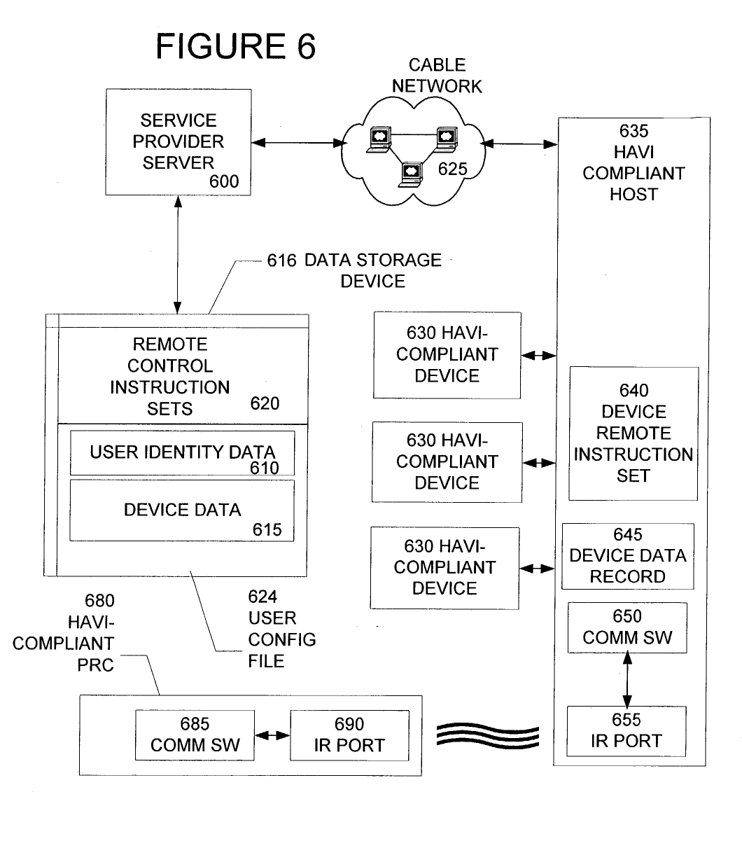

FIG. 6 illustrates an embodiment according to the present invention in which HAVi-compliant devices are connected to a HAVi-compliant host. A HAVi-compliant host is a device in a HAVi-compliant network that acts as a hub for all other devices on that network. By way of illustration and not as a limitation, a HAVi-compliant host may be a set top box, a digital receiver or a PC. The HAVi-compliant host communicates with all other HAVi-compliant components that are connected to the HAVi-compliant host and with HAVi-compliant devices connected to HAVI-complaint components.

Referring to FIG. 6, a block diagram illustrating a method of conveying information about devices that a user desires to control with a PRC to a service provider. Configuration server 600 is connected to HAVi-compliant host 635 over cable network 625. HAVi-compliant host 635 comprises communication software 650 and an IR port 655. Connected to HAVi-compliant host 635 are HAVi-compliant devices 630. While three HAVi-compliant devices 630 are illustrated, this is not meant as a limitation. Any number of HAVi-compliant devices 630 may be connected to HAVi-compliant host 635 without departing from the scope of the present invention. A HAVi-compliant PRC 680 communicates with HAVi-compliant host 635 through IR port 690. As would be apparent to those skilled in the art of the present invention, the link between the HAVi-compliant host 635 and the HAVi-compliant PRC 680 is not limited to the IR link illustrated in FIG. 6 but may be established by other means. By way of example and not as a limitation, this link may be a wired link or a wireless RF-link.

When the HAVi-compliant host 635 is first powered on it identifies each of the HAVi-compliant devices connected to it. The HAVi-compliant host 635 maintains a device data record 640 for each HAVi-compliant device 630 connected to it. If a new HAVi-compliant device 630 is found a device data record 640 is created for that device. Additionally, the HAVi-compliant host 635 sends a “hello” message from its IR port 655 to the IR port 690 of HAVi-compliant PRC 680. HAVi-compliant PRC 680 answers with a response message that comprises an id value unique to the HAVi-compliant PRC 680. The response message is generated by communication software 685.

The HAVi-compliant host 635 sends a registration message over cable network 625 to service provider 600. The registration message comprises the id value of the HAVi-compliant PRC 680, the device data record 640 of each HAVi-compliant device connected to HAVi-compliant host 635, and a MAC address of the HAVi-compliant host 635. In one embodiment, the user obtains the HAVi-compliant host 635 from service provider. In this embodiment, the service provider maintains a user identity file on each user and associates the MAC address of the HAVi-compliant host 635 with a particular user. Based on the MAC address provided in the registration message, the service provider 600 associates the HAVi-compliant PRC and the device data record 640 with the user of the HAVi-compliant host 635 and stores the device data record 640 in a user configuration file 624. In an alternate embodiment, the user obtains a HAVi-compliant host 635 from another source and notifies the service provider of the MAC address of the HAVi-compliant host 635 before installation of the host.

In either case, the user is automatically registered with the service provider 600. A user configuration file 624 is created for the user and stored in data storage device 616. The user configuration file 624 comprises user identity data 610 that associates configuration file 624 with the user and device data 615. Additionally, data storage device 616 stores remote control instruction sets 620 for a plurality of HAVi-compliant devices from a plurality of device manufacturers.

Upon the completion of registration, service provider 600 sends a configuration message to HAVi-compliant host 635 over cable network 625. The configuration message comprises the remote control instruction set for each HAVi-compliant device connected to HAVi-compliant host 635. The remote control instruction set of a HAVi-compliant device is selected from a list of remote control instruction sets 620 based on the device data 615. Upon receipt of the configuration message, HAVi-compliant host 635 stores each received remote control instruction set in received remote control instruction set 640 and then issues a programming message to HAVi-compliant PRC 680 over the complementary IR ports 655 and 690. The programming message comprises an installation script and remote control instruction set for each HAVi-compliant device connected to HAVi-compliant host 635. HAVi-compliant PRC 680 executes the script and configures itself to operate the HAVi-compliant devices in accordance with the remote control instruction set. Upon completion of the configuration of each remote control instruction set, the PRC is able to directly control each remotely controllable HAVi-compliant device with the HAVi-compliant PRC.

In yet another embodiment of the present invention, the registration message is sent each time HAVi-compliant host 635 is rebooted or when a HAVi-compliant device 630 is connected to, or disconnected from, the HAVi-compliant host 635. In this way, the user configuration file 624 is updated. In an alternate embodiment, a newly connected device is automatically added to the user configuration file 624, but a device that has been disconnected is not removed from the configuration file 624 without first confirming with the user that removal is appropriate.

In another embodiment of the present invention, the HAVi-compliant PRC comprises a display and a plurality of buttons. In this embodiment, a remote control instruction set is implemented as virtual buttons on the display, as commands to be entered through the plurality of buttons, or by a combination of buttons and virtual buttons. In yet another embodiment, the HAVi-compliant PRC associates a particular implementation of a remote control instruction set with a user-selected display.

In still another embodiment, the devices 630, 635, and 680 are compliant with the IEEE 1394 protocols (which protocols comprise the A/VC protocol), but not with the HAVi protocol. The operation of this embodiment does not materially differ from the process flow illustrated in FIG. 6. However, without compliance with the HAVi standard, the ability of devices to communicate information among the other devices will depend on how the 1394 protocols have been implemented.

A method for programming a programmable remote control device has now been illustrated. As described herein, the method for programming a programmable remote control device simplifies the task of programming a programmable remote control as well as safeguarding the device record used to program the programmable remote control. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

What is claimed is:

1. A method for programming a programmable remote control over a network from a configuration file, wherein the network comprises a user computer and a configuration server connected via the network, the method comprising:
sending from the user computer a storage request;
receiving at the configuration server the storage request, wherein the storage request
comprises a user identifier and one or more device identifiers each associated with a unique controllable device; and
storing in a configuration file each device identifier in association with the user identifier.

2. The method of claim 1, wherein the user computer comprises a set top box.

3. The method of claim 1, wherein each of the one or more device identifiers is uniquely associated with a television, a television receiver, an audio-video receiver, a DVD player, a VCR, and an MP3 player.

4. The method of claim 1, wherein the network is selected from a group consisting of a wireless network, a satellite network, a cable network, the public switched telephone network, and a packet switched network.

5. A method for programming a programmable remote control over a network from a configuration file, wherein the network comprises a user computer and a configuration server connected via the network, wherein the configuration server is connected to a configuration file associated with a user via a user identifier, and wherein the configuration file has stored therein one or more device identifiers each associated with a unique controllable device, the method comprising:
sending from the user computer a programming request;
receiving at the configuration server the programming request, wherein the programming request comprises the user identifier;
selecting the configuration file associated with the user identifier;
selecting a remote control instruction set associated with each device identifier stored in the configuration file;
for each device identifier stored in the configuration file, sending the selected remote control instruction set to the user computer;
receiving at the user computer each selected remote control instruction set;
communicating each selected remote control instruction set to a programmable remote control; and
programming the programmable remote control in accordance with each selected remote control instruction set.

6. The method of claim 5, wherein the user computer comprises a set top box.

7. The method of claim 5, wherein each of the one or more device identifiers is uniquely associated with a television, a television receiver, an audio-video receiver, a DVD player, a VCR, and an MP3 player.

8. The method of claim 5, wherein communicating each selected remote control instruction set to a programmable remote control comprises sending each remote control instruction set to the programmable remote control over a link between the user computer and the programmable remote control.

9. The method of claim 8, wherein the link is selected from the group consisting of an infrared link, a wireless link, and a wired link.

10. The method of claim 5, wherein the method further comprises:
receiving at the configuration server an add-new-device request from the user computer, wherein the add-new-device request comprises a user identifier and a device identifier; and
adding the device identifier of the new device to the configuration file associated with the user identifier.

11. The method of claim 5, wherein the method further comprises:
receiving at the configuration server a delete-existing-device request from the user computer, wherein the delete-existing-device request comprises a user identifier and a device identifier; and
deleting the device identifier of the existing device of the configuration file associated with the user identifier.

12. The method of claim 5, wherein the network is selected from a group consisting of a wireless network, a satellite network, a cable network, the public switched telephone network, and a packet switched network.

13. A method for programming a HAVi-compliant programmable remote control over a network from a configuration file, wherein the network comprises a HAVi-compliant host and a configuration server connected via the network, the method comprising:
sending from the HAVi-compliant host a registration message, wherein the registration message comprises the MAC address of the HAVi-compliant host and one or more device data records each associated with a HAVi-compliant device connected to the HAVi-compliant host;
receiving at the configuration server the registration message; and
storing in a configuration file the device data records, wherein the configuration file is associated with the HAVi-compliant host via the MAC address.

14. The method of claim 13, wherein the MAC address associates a user with a user identifier.

15. The method of claim 13, wherein the HAVi-compliant host comprises a set top box.

16. The method of claim 13, wherein the HAVi-compliant device comprises a HAVi-compliant programmable remote control having a programmable remote control identifier.

17. The method of claim 16, wherein the registration message further comprises the programmable remote control identifier, and wherein the method further comprises associating the device data records with the programmable remote control identifier.

18. The method of claim 13, wherein the HAVi-compliant device is selected from the group consisting of a television, a television receiver, an audio-video receiver, a DVD player, a VCR, and an MP3 player.

19. The method of claim 13, wherein the network is selected from a group consisting of a wireless network, a satellite network, a cable network, the public switched telephone network, and a packet switched network.

20. A method for programming a HAVi-compliant programmable remote control over a network from a configuration file, wherein the network comprises a HAVi-compliant host and a configuration server connected via the network, wherein the configuration server is connected to the configuration file, wherein the configuration file has stored therein a MAC address of the HAVi-compliant host, and wherein the MAC address is associated with a device data record of each HAVi-compliant device connected to the HAVi-compliant host, the method comprising:
sending from the HAVi-compliant host a programming message, wherein the programming message comprises the MAC address of the HAVi-compliant host;
receiving at the configuration server the programming message;
selecting the configuration file associated HAVi-compliant host;
selecting a remote control instruction set for each HAVi-compliant device for which a device data record is stored in the configuration file;
sending the selected remote control instruction set to the HAVi-compliant host;
receiving at the HAVi-compliant host each selected remote control instruction set;
communicating each selected remote control instruction set to the HAVi-compliant programmable remote control; and
programming the HAVi-compliant programmable remote control in accordance with each selected remote control instruction set.

21. The method of claim 20, wherein selecting the configuration file associated with the HAVi-compliant host comprises selecting the configuration file associated with the MAC address of the HAVi-compliant host.

22. The method of claim 20, wherein the MAC address of the HAVi-compliant host associates a user with a user identifier.

23. The method of claim 22, wherein selecting the configuration file associated with the HAVi-compliant host comprises selecting the configuration file associated with the user identifier.

24. The method of claim 20, wherein the HAVi-compliant host comprises a set top box.

25. The method of claim 20, wherein the HAVi-compliant device is selected from the group consisting of a television, a television receiver, an audio-video receiver, a DVD player, a VCR, and an MP3 player.

26. The method of claim 20, wherein the device data record of each HAVi-compliant device connected to the HAVi-compliant host is associated with the HAVi-compliant programmable remote control via a programmable remote control identifier, wherein the programming message further comprises the programmable remote control identifier, and, wherein selecting a remote control instruction set for each HAVi-compliant device for which a device data record is stored in the configuration file comprises selecting each device data record associated with the programmable remote control identifier.

27. The method of claim 20, wherein communicating each selected remote control instruction set to a HAVi-compliant programmable remote control comprises sending each remote control instruction set to the HAVi-compliant programmable remote control over a link between the HAVi-compliant host and the HAVi-compliant programmable remote control.

28. The method of claim 27, wherein the link is selected from the group consisting of an infrared link, a wireless link, and a wired link.

29. The method of claim 20, wherein the network is selected from a group consisting of a wireless network, a satellite network, a cable network, the public switched telephone network, and a packet switched network.

30. The method of claim 20, wherein the HAVi-compliant programmable remote control comprises a display having a plurality of screens, each screen comprising a plurality of programmable objects, and, wherein programming the HAVi-compliant programmable remote control in accordance with each selected remote control instruction set comprises associating a programmable instruction set with one of the plurality of screens and a programmable instruction with one of the plurality of objects of that one of the plurality of screens.

31. The method of claim 20, wherein the HAVi-compliant programmable remote control comprises a plurality of programmable keys, and, wherein programming the HAVi-compliant programmable remote control in accordance with each selected remote control instruction set comprises associating a programmable instruction with one of the plurality of programmable keys.

32. A system for programming a programmable remote control, the system comprising:
a configuration server adapted to receive a storage request from a user computer, wherein the storage request comprises a user identifier and one or more device identifiers each associated with a unique controllable device; and
a configuration file accessible to the configuration server associated with the user identifier and adapted to receive from the configuration server and store the one or more device identifiers.

33. The system of claim 32, wherein the user computer comprises a set top box.

34. The system of claim 32, wherein each of the one or more device identifiers is uniquely associated with a television, a television receiver, an audio-video receiver, a DVD player, a VCR, and an MP3 player.

35. The system of claim 32, wherein:
the configuration server is further adapted to:
receive a programming request from the user computer, wherein the programming request comprises a user identifier;
select the configuration file associated with the user identifier;
select a remote control instruction set associated with each device identifier stored in the configuration file; and
for each device identifier stored in the configuration file, send to the user computer the selected remote control instruction set; and
the user computer is adapted to:
receive each selected remote control instruction set;
communicate to a programmable remote control each selected remote control instruction set; and
program the programmable remote control in accordance with each selected remote control instruction set.

36. The system of claim 35, wherein the user computer is further adapted to communicate each selected remote control instruction set to a programmable remote control over a link between the user computer and the programmable remote control.

37. The system of claim 36, wherein the link is selected from the group consisting of an infrared link, a wireless link, and a wired link.

38. The system of claim 35, wherein the configuration server is further adapted to:
receive an add-new-device request from the user computer, wherein the add-new-device request comprises the user identifier and a device identifier; and
add the device identifier of the new device to the configuration file associated with the user identifier.

39. The system of claim 35, wherein the configuration server is further adapted to:
receive a delete-existing-device request from the user computer, wherein the delete-existing-device request comprises the user identifier and a device identifier; and
delete the device identifier of the existing device of the configuration file associated with the user identifier.

40. A system for programming a HAVi-compliant programmable remote control, the system comprising:
a configuration server adapted to receive a registration message from a HAVi-compliant host, wherein the registration message comprises the MAC address of the HAVi-compliant host and one or more device data records each associated with a HAVi-compliant device; and
a configuration file accessible to the configuration server and adapted to receive from the configuration server the MAC address of the HAVi-compliant host and to associate with the MAC address a device data record of each HAVi-compliant device connected to the HAVi-compliant host.

41. The system of claim 40, wherein:
the configuration server is further adapted to:
receive a programming message from the HAVi-compliant host;
select the configuration file associated with the HAVi-compliant host;
select a remote control instruction set for each HAVi-compliant device for which a device data record is stored in the configuration file; and
send each selected remote control instruction set to the HAVi-compliant host; and
the HAVi-compliant host is adapted to:
receive each selected remote control instruction set;
communicate each selected remote control instruction set to a HAVi-compliant programmable remote control; and
program the HAVi-compliant programmable remote control in accordance with each selected remote control instruction set.

42. The system of claim 41, wherein selecting the configuration file associated with the HAVi-compliant host comprises selecting the configuration file associated with the MAC address of the HAVi-compliant host.

43. The system of claim 41, wherein the MAC address of the HAVi-compliant host associates a user with a user identifier.

44. The system of claim 43, wherein selecting the configuration file associated with the HAVi-compliant host comprises selecting the configuration file associated with the user identifier.

45. The system of claim 41, wherein the HAVi-compliant host is further adapted to send each remote control instruction set to the HAVi-compliant programmable remote control over a link between the HAVi-compliant host and the HAVi-compliant programmable remote control.

46. The system of claim 45, wherein the link is selected from the group consisting of an infrared link, a wireless link, and a wired link.

47. The system of claim 41, wherein the registration message further comprises a programmable remote control identifier associated with a HAVi-compliant programmable remote control and, wherein the configuration file is further adapted to associate device data records with the programmable remote control identifier.

48. The system of claim 47, wherein:
the configuration server is further adapted to:
receive a programming message from the HAVi-compliant host;
select the configuration file associated the HAVi-compliant host;
select the device data records associated with the programmable remote control identifier;
select a remote control instruction set for each HAVi-compliant device for which an device data record is stored in the configuration file; and
send each selected remote control instruction set to the HAVi-compliant host; and
the HAVi-compliant host is adapted to:
receive each selected remote control instruction set;
communicate each selected remote control instruction set to a HAVi-compliant programmable remote control; and
program the HAVi-compliant programmable remote control in accordance with each selected remote control instruction set.

49. The system of claim 48, wherein selecting the configuration file associated with the HAVi-compliant host comprises selecting the configuration file associated with the MAC address of the HAVi-compliant host.

50. The system of claim 48, wherein the MAC address of the HAVi-compliant host associates a user with a user identifier.

51. The system of claim 50, wherein selecting the configuration file associated with the HAVi-compliant host comprises selecting the configuration file associated with the user identifier.

52. The system of claim 48, wherein the HAVi-compliant host is further adapted to send each remote control instruction set to the HAVi-compliant programmable remote control over a link between the HAVi-compliant host and the HAVi-compliant programmable remote control.

53. The system of claim 52, wherein the link is selected from the group consisting of an infrared link, a wireless link, and a wired link.

54. The system of claim 40, wherein the HAVi-compliant programmable remote control comprises a display having a plurality of screens, each screen comprising a plurality of programmable objects, and, wherein programming the HAVi-compliant programmable remote control in accordance with each selected remote control instruction set comprises associating a programmable instruction set with one of the plurality of screens and a programmable instruction with one of the plurality of objects of that one of the plurality of screens.

55. The system of claim 40, wherein the HAVi-compliant programmable remote control comprises a plurality of programmable keys, and wherein programming the HAVi-compliant programmable remote control in accordance with each selected remote control instruction set comprises associating a programmable instruction with one of the plurality of programmable keys.

56. A method for programming a HAVi-compliant programmable remote control over a network from a configuration file, wherein the network comprises a HAVi-compliant host and a configuration server connected via the network, the method comprising:
sending from the HAVi-compliant host a update message, wherein the update message comprises the MAC address of the HAVi-compliant host and one or more device data records each associated with a HAVi-compliant device connected to the HAVi-compliant host;
receiving at the configuration server the update message;
comparing the update message with the configuration file associated with the HAVi-compliant host;
determining whether each device identifier sent in the update message matches a device identifier stored in the configuration file;
if a sent device identifier does not match any stored device identifier of the configuration file, storing the sent device identifier in the configuration file in association with the user identifier.

57. The method of claim 56, wherein the update message is sent on boot-up of the HAVi-compliant host.

58. The method of claim 56, wherein the update message is sent when a HAVi-compliant device is first connected to the HAVi-compliant host.

59. A method for programming a HAVi-compliant programmable remote control over a network from a configuration file, wherein the network comprises a HAVi-compliant host and a configuration server connected via the network, the method comprising:
sending from the HAVi-compliant host a update message, wherein the update message comprises the MAC address of the HAVi-compliant host and one or more device data records each associated with a HAVi-compliant device connected to the HAVi-compliant host;
receiving at the configuration server the update message;
comparing the update message with the configuration file associated with the HAVi-compliant host;
determining whether each device identifier stored in the configuration file matches a device identifier sent in the configuration message;
if a stored device identifier does not match any sent device identifier, deleting the stored device identifier from the configuration file associated with HAVi-compliant host.

60. The method of claim 59, wherein the update message is sent on boot-up of the HAVi-compliant host.

61. The method of claim 59, wherein the update message is sent when a HAVi-compliant device connected to the HAVi-compliant host is disconnected from the HAVi-compliant host.

62. A method for programming a programmable remote control over a network from a configuration file, wherein the network comprises a user computer and a configuration server connected via the network, wherein the configuration server is connected to a configuration file associated with a user via a user identifier, and wherein the configuration file has stored therein one or more device identifiers each associated with a unique controllable device, the method comprising:
sending from the user computer a storage request;
receiving at the configuration server the storage request, wherein the storage request comprises a user identifier and one or more device identifiers each associated with a unique controllable device;
storing in a configuration file each device identifier in association with the user identifier;
sending from the user computer a programming request;
receiving at the configuration server the programming request, wherein the programming request comprises the user identifier;
selecting the configuration file associated with the user identifier;
selecting a remote control instruction set associated with each device identifier stored in the configuration file;
for each device identifier stored in the configuration file, sending the selected remote control instruction set to the user computer;
receiving at the user computer each selected remote control instruction set;
sending each remote control instruction set to the programmable remote control over a link between the user computer and the programmable remote control; and
executing at the programmable remote control each remote control instruction set.
